(19) United States
(12) Patent Application Publication
(10) Pub. No.: US 2021/0348503 A1
(43) Pub. Date: Nov. 11, 2021

(54) SELF-CALIBRATION METHOD AND SYSTEM OF SOLID-STATE RESONATOR GYROSCOPE

(71) Applicant: Institute of geology and geophysics, Chinese academy of sciences, Beijing (CN)

(72) Inventor: Xu XUE, Beijing (CN)

(21) Appl. No.: 17/248,897

(22) Filed: Feb. 12, 2021

Related U.S. Application Data
(63) Continuation of application No. PCT/CN2020/090521, filed on May 15, 2020.

(30) Foreign Application Priority Data
May 11, 2020 (CN) 202010394129.0

(51) Int. Cl. E21B 47/024; G01C 25/00; G01C 21/16; G01C 19/56; G01H 17/00; E21B 7/04

(52) U.S. Cl. CPC E21B 47/024; G01C 25/005; E21B 7/04; G01C 19/56; G01H 17/00; G01C 21/16

(57) ABSTRACT

A self-calibration method and system of a solid-state resonator gyroscope, which can realize the separation of the bias error from the angular rate, and fundamentally solve the problem of repeatability errors; this calibration method acquires steady-state signals of key monitoring points in a gyroscope in different working modes in real time by externally feeding excitation signals, and realizes the separation of the bias error from the input angular rate by an algorithm, thus calibrating the repeatability error of the gyroscope. The excitation signals include first and second excitation signals; the first and second excitation signals are respectively combined with demodulated primary mode detection signal D₋ₓ and demodulated secondary mode detection signal D_{+y} to realize feeding; the key monitoring points include output points of an antinode controller and output points of a node controller, and realize the separation of the bias error from the input angular rate according to the excitation signals and acquired signals of monitoring points. The technical solution provided can be applied to a measurement while drilling system or a navigation system.

### FIELD

The present invention relates to the technical field of underground drilling attitude measurement, in particular to a self-calibration method and system of a solid-state resonator gyroscope.

### BACKGROUND

When the inertial navigation system composed of a gyroscope and an accelerometer is used for initial alignment or north finding, the accuracy of azimuth measurement depends on the observable component of constant drift of a gyroscope in the geographical east direction. When the gyroscope is completely in the horizontal section, for example, the well inclination angle is 90°; in the east-west direction, the gyro output in the geographical east direction mainly comes from the Z-axis gyroscope (as shown in FIG. 1), which cannot be eliminated because its constant drift is unobservable. Therefore, a Gyro Measurement while Drilling (GMD) cannot achieve satisfactory measurement accuracy in the east-west direction at all attitude, especially in the horizontal section.

A Gyro-Compass-Index method is to add a rotating mechanism from the outside, and it is assumed that the bias constant value of the gyroscope does not change in a short time during the rotation process, but only the polarity of the sensing axis changes, by changing the direction of the sensing axis of the gyroscope, the purpose of eliminating a drift error is achieved. From the perspective of the modern control theory, the observer is added by changing the position, so as to realize optimal estimation. However, for an external two-position-changing analytical method at present, the azimuth alignment accuracy becomes worse with the increase of the well inclination angle under the east-west well trajectory.

In order to realize that the azimuth accuracy is better than 1° at a all-attitude angle (i.e., the well inclination angles cover 0°-90°, and the drilling direction is an east-west or north-south direction or a direction of included angles of any combination), the conventional method is to add a position change with another degree of freedom, that is, to realize the position change of a Z-axis gyroscope along the diameter of an exploring tube, thus realizing the separation of the constant drift of the Z-axis gyroscope, thereby improving the observability. However, it is extremely difficult to realize the position changing modulation of the Z-axis gyroscope in the horizontal direction due to the limitation of the narrow underground space. In addition, two sets of position changing mechanisms will increase the difficulty of GMD design and reduce the reliability of products. Therefore, the present invention attempts to solve the calibration problem of the constant drift of the gyroscope from other technical dimensions.

The drift error of a solid-state resonator gyroscope mainly comes from frequency split, anisodamping error and control-loop errors. The angular random walk coefficient mainly depends on control accuracy of frequency and phase locked loop (PLL), and its magnitude determines the rapidity of GMD north finding. The control-loop errors mainly come from the error of a closed-loop controller which maintains the resonator energy. The advantage of high Q value and low damping is that the resonator energy needs to be kept small, thus reducing the bias error caused by control-loop errors. Anisodamping error is an important factor of a bias repeatability error.

The angular random walk coefficient of a high-temperature solid-state resonator gyroscope can reach 0.005 deg/\sqrt{h}, which affects the alignment time and the order of magnitude of its impact on the alignment accuracy is far less than the target value. Through the design of a high Q value, the driving energy is reduced, thus reducing the control-loop errors, which is also the design guarantee of the solid-state resonator gyroscope. The bias constant value caused by anisodamping error is the only drift error that needs to be identified. This error is in the same phase with the Coriolis force, which cannot be separated by demodulation. Furthermore, because time or temperature brings the change of the anisodamping error of the resonator, it is also the main source of a repeatability error of the gyroscope.

Therefore, it is necessary to study a self-calibration method and system of a solid-state resonator gyroscope to deal with the shortcomings of the existing technology, so as to solve or alleviate one or more of the above problems.

### SUMMARY

In view of the above, the present invention provides a self-calibration method and system of a solid-state resonator gyroscope, which can realize the separation of a bias error from an angular rate, fundamentally solve the problem of the repeatability error, and meet the requirement that the measurement accuracy at a whole well inclination angle is better than 1°, even up to 0.06°.

In one aspect, a self-calibration method of a solid-state resonator gyroscope is provided, wherein the method acquires output signals of key monitoring points in the gyroscope in different working modes in real time by externally feeding excitation signals, and realizes separation of a bias error from an input angular rate by an algorithm, so as to calibrate a repeatability error of the gyroscope.

The above-mentioned aspect and any possible implementations further provide an implementation: the excitation signals include a first excitation signal and a second excitation signal; the first excitation signal and the second excitation signal are respectively combined with a demodulated primary mode detection signal D₋ₓ and a demodulated secondary mode detection signal D_{+y} to realize feeding.

The above-mentioned aspect and any possible implementations further provide an implementation: the key monitoring points in the gyroscope include output points of an antinode controller and output points of a node controller; state observers are respectively arranged at the output points of the antinode controller and the output points of the node controller, and steady-state signals of the gyroscope in a first working mode and in a second working mode are output through the state observers; and the estimation of the bias error and the input angular rate is realized according to the feed excitation signals and the output steady-state signals.

The above-mentioned aspect and any possible implementations further provide an implementation: contents of the steady-state signal include: a force for maintaining the vibration amplitude of an antinode axis, a Coriolis force caused by the input angular rate, a precession Coriolis force generated by externally feeding excitation and a harmonic force caused by anisodamping error.

The above-mentioned aspect and any possible implementations further provide an implementation: the method includes the following specific steps:

S1, performing scale factor calibration by the gyroscope in the first working mode, and obtaining a residual value δSF_{P1} after self-calibration of a first position scale factor according to a known excitation signal externally fed;

S2, outputting steady-state signals Eₐ¹ and Eₚ¹ in the first working mode by the state observers;

S3, switching from the first working mode to the second working mode by the gyroscope in a manner of free precession;

S4, performing scale factor calibration by the gyroscope in the second working mode, and obtaining a residual value δSF_{P2} after self-calibration of a second position scale factor according to a known excitation signal externally fed;

S5, outputting steady-state signals Eₐ² and Eₚ² in the second working mode by the state observers; and

S6, separating the bias error and the input angular rate according to the results of steps S1 and S2, S4 and S5 so as to realize the self-calibration of the gyroscope.

The above-mentioned aspect and any possible implementations further provide an implementation: in the first working mode, the antinode axis of the gyroscope is X axis, a node axis is Y axis and a precession angle parameter is θ=0°; in the second working mode, the antinode axis of the gyroscope is Y axis, the node axis is X axis and the precession angle parameter is θ=90°.

The above-mentioned aspect and any possible implementations further provide an implementation: θ=2λ, λ is a precession angle of the antinode axis relative to an initial position.

The above-mentioned aspect and any possible implementations further provide an implementation: the process of free precession in step S3 includes: after receiving a precession instruction, the antinode axis and node axis of the gyroscope are precessed according to a preset fixed precession angular rate until θ=90°.

The above-mentioned aspect and any possible implementations further provide an implementation: after step S5 is completed, the antinode axis is reset, the calibration is finished, the reset process of the antinode axis and the calculation process of step S6 do not interfere with each other and are executed in no particular order.

In another aspect, a measurement while drilling system is provided, including a strapdown inertial navigation system which includes a plurality of gyroscopes and a plurality of accelerometers, wherein, the strapdown inertial navigation system adopts any one of the self-calibration methods to carry out bias self-calibration of the gyroscope, so as to improve accuracy of measurement while drilling in directional drilling.

The above-mentioned aspect and any possible implementations further provide an implementation: the measurement while drilling system judges whether a drill collar is in a static state, and if the drill collar is in the static state, the measurement while drilling system sends a self-calibration instruction to a microcontroller unit (MCU) module of the gyroscope to start self-calibration.

The above-mentioned aspect and any possible implementations further provide an implementation: the specific content of judging whether the drill collar is in the static state is one or two of a first judging method and a second judging method;

the first judging method specifically is: judging whether a sensing-velocity observation value and/or a sensing-angular-rate observation value is less than a judgment threshold value, if the sensing-velocity observation value and/or the sensing-angular-rate observation value is less than the judgment threshold value, judging that the drill collar is in the static state, otherwise, judging that the drill collar is not in a static state;

the second judging method specifically is: judging whether a disturbance amount of external mud and/or a vibration amount sensed by a vibration sensor is less than a set threshold value; if the disturbance amount of external mud and/or the vibration amount sensed by the vibration sensor is less than the set threshold value, judging that the drill collar is in the static state; otherwise, judging that the drill collar is not in the static state.

The above-mentioned aspect and any possible implementations further provide an implementation: the sensing-velocity observation value is an acceleration magnitude; the sensing-angular-rate observation value is a root mean square value of the angular rate of the gyroscope.

The above-mentioned aspect and any possible implementations further provide an implementation: self-calibration of two and more gyroscopes is carried out by real-time polling;

specifically, the gyroscopes are self-calibrated one by one in turn, and the gyroscopes being self-calibrated do not participate in a navigation algorithm of the strapdown inertial navigation system, while other gyroscopes work normally.

The above-mentioned aspect and any possible implementations further provide an implementation: a final azimuth measurement accuracy of the measurement while drilling system reaches 0.06°.

In still another aspect, a continuous navigation measurement system is provided, including a strapdown inertial navigation system which includes a triaxial gyroscope and a triaxial accelerometer; wherein the strapdown inertial navigation system adopts any one of the self-calibration methods to carry out bias self-calibration of the gyroscope, so as to improve azimuth measurement accuracy in a navigation process.

Compared with the prior art, the present invention can obtain the following technical effects: switching between the working mode 1 and the working mode 2 is realized through free precession, and energy loss during switching is avoided. A state observer is added to the control circuit of the gyroscope, and the drift error is separated from the angular rate by the self-calibration method, thus improving the azimuth measurement accuracy of a GMD. Using the self-calibration method of free precession can fundamentally solve the problem of repeatability errors, and achieve that the measurement accuracy is better than 1° under a whole well inclination angle.

Obviously, it is not necessary for any product of the present invention to achieve all the above technical effects at the same time.

### BRIEF DESCRIPTION OF THE DRAWINGS

In order to explain the technical solution of the embodiments of the present invention more clearly, the drawings used in the embodiments will be briefly introduced below. Obviously, the drawings in the following description are only some embodiments of the present invention, and for those skilled in the art, other drawings can be obtained according to these drawings without paying creative work.

FIG. 1 is a schematic diagram of bias elimination by changing a position of a gyroscope.

FIG. 2 is a flowchart of self-calibration of a gyroscope according to an embodiment of the present invention.

FIG. 3 is a schematic block diagram of a closed-loop control system of a gyroscope according to an embodiment of the present invention.

FIG. 4 is a control block diagram of a gyroscope in working mode 1 according to an embodiment of the present invention.

FIG. 5 is a schematic diagram of a vibration mode of a resonator in working mode 1 according to an embodiment of the present invention.

FIG. 6 is a control block diagram of a gyroscope in working mode 2 according to an embodiment of the present invention.

FIG. 7 is a schematic diagram of a vibration mode of a resonator in working mode 2 according to an embodiment of the present invention.

FIG. 8 is a block diagram of GMD gyroscope self-calibration and self-test control according to an embodiment of the present invention.

FIG. 9 is a schematic diagram of the self-calibration process of a gyroscope according to an embodiment of the present invention.

FIG. 10 is a schematic diagram of electrode arrangement of a solid-state resonator gyroscope according to an embodiment of the present invention.

FIG. 11 is a simplified Foucault pendulum model diagram of a fully symmetric resonator according to an embodiment of the present invention.

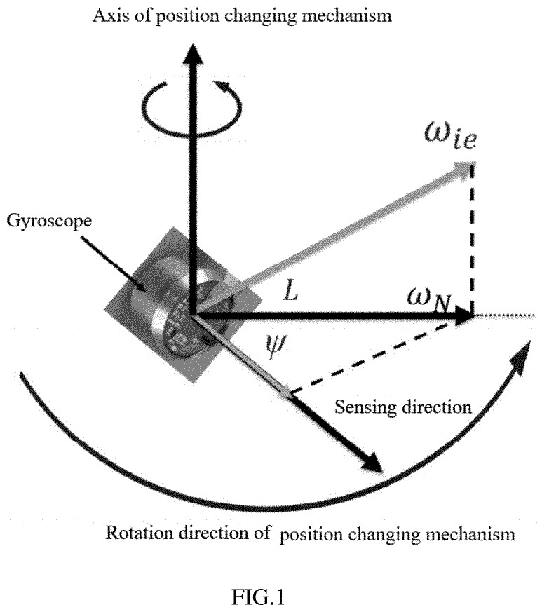

### DETAILED DESCRIPTION

In order to better understand the technical solution of the present invention, embodiments of the present invention will be described in detail with reference to the accompanying drawings.

It should be clear that the described embodiments are only part of the embodiments of the present invention, not all thereof. Based on the embodiments of the present invention, all other embodiments obtained by those skilled in the art without creative work fall within the claimed scope of the present invention.

Terms used in the embodiments of the present invention are for the purpose of describing specific embodiments only, and are not intended to limit the present invention. As used in the embodiments of the present invention and the appended claims, the singular forms “a”, “the” and “this” are also intended to include the plural forms unless the context clearly indicates other meaning.

Coriolis vibratory gyroscopes are divided into type I and type II. Type I mostly adopts a tuning fork scheme, such as an early micro-electro-mechanical system (MEMS) comb gyroscope and a quartz tuning fork gyroscope. Type II adopts a fully symmetric structure, which greatly improves the isotropy of frequency and damping, and precisely because of the design of a symmetric structure, the gyroscope conveniently realizes self-calibration and self-test, and can realize the unity of the force balance mode (rate mode) and the whole-angle mode (rate integrating mode). Representative products such as an MEMS ring resonator gyroscope, an MEMS-Disk resonator gyroscope and a hemispherical resonator gyroscope (HRG).

According to the present invention, by taking the fully symmetrical structure and high quality factor characteristics of the type II resonator gyroscope, and a set of Gyro Compass Index algorithm, called “Index In Loop”, which is a self-calibration method of free precession of an internal resonator, is added in the control circuit of the gyroscope by constructing an observer, so that the drift error is separated from the angular rate, thereby improving the azimuth measurement accuracy of the GMD.

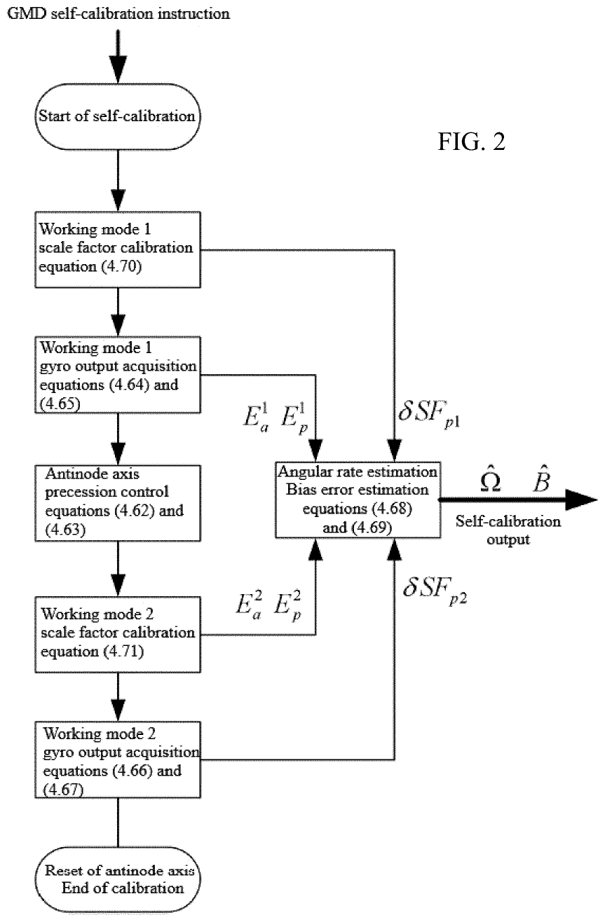

According to the self-calibration method of the present invention, the resonator is rotated by free precession to be in two different positions, so that the gyroscope is switched between the working mode 1 and the working mode 2, and the energy loss during switching is avoided. Using the self-calibration method of free precession can fundamentally solve the problem of repeatability errors, and achieve that the measurement accuracy is better than 1° on the condition of the whole well inclination angle (0°˜90°). The flowchart of the self-calibration method is shown in FIG. 2.

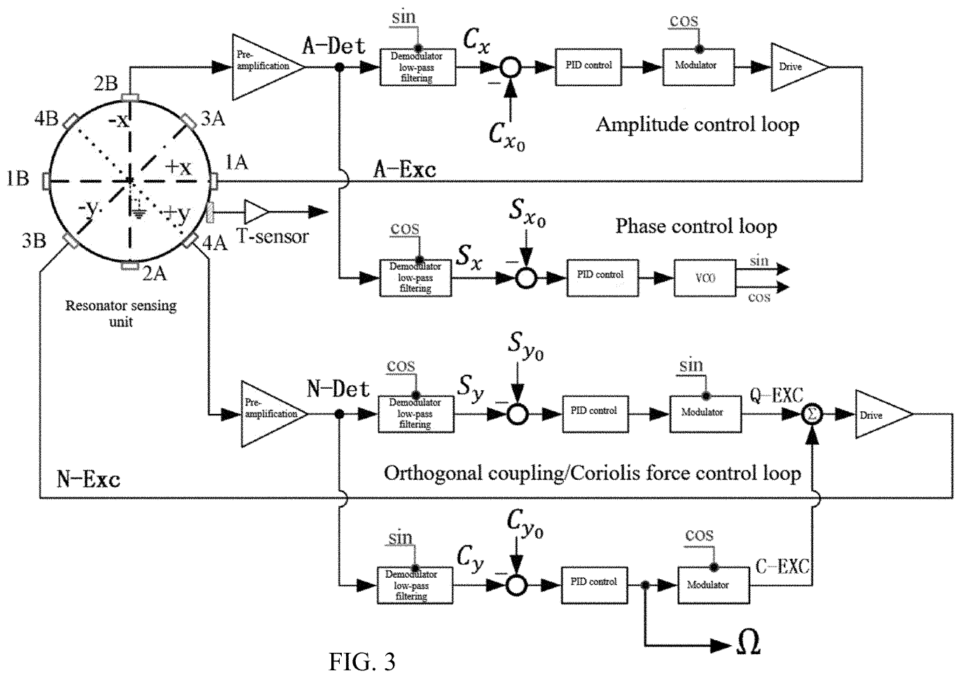

FIG. 3 is a schematic block diagram of a closed-loop control system of the gyroscope. In FIG. 3, Cₓ and C_{y} are quadrature components of demodulation values of a fixed driving axis, Sₓ and S_{y} are quadrature components of demodulation values of a fixed measuring axis, Cₓ represents the amplitude of the driving axis, Sₓ represents the phase correlation of the driving axis, C_{y} represents the Coriolis force correlation of a detecting axis, S_{y} represents quadrature coupling, and four coefficients are used as inputs of the closed-loop control system, which respectively realize:

1) amplitude closed-loop control: an automatic gain control (AGC) loop is usually adopted, so that the resonator vibrates with an equal amplitude on the driving axis, and the vibration amplitude is maintained to a preset value, namely: Cₓ=Gₓ₀,

2) phase closed-loop control: generally, a phase-locked loop circuit (PLL) is used to make the phase difference δφ=φ−\hat{φ} tend to zero through proportional integral derivative (PID) control. Similar to amplitude control, setting Sₓ₀=0 realizes that the resonator works at its natural working frequency ωₓ,

3) Coriolis force closed-loop control: through PID closed-loop control, it is realized that the closed-loop feedback force balances the input Coriolis force in real time, and the standing wave is fixedly bound to a fixed electrode, that is, the precession angle θ=θ₀, which is usually set as θ₀=0. The error C_{y} representing the real-time precession angle is the input of a PID control signal, which is implemented by control strategy, so as to realize the error C_{y}=θ₀=0,

4) quadrature coupling closed-loop control: similar to Coriolis force closed-loop control, S_{y} representing the quadrature coupling error is taken as the input of the PID control signal, and S_{y}=S_{y0}=0 is realized through closed-loop control.

According to the closed-loop control circuit of the gyroscope, a state observer is added in the closed-loop control circuit of the gyroscope for observation, and the position of the resonator of the gyroscope is changed by procession under the condition of external excitation, so that the drift error is separated from the angular rate, and then the bias is estimated to realize self-calibration. An MCU calibration processing algorithm unit is embedded in the closed-loop control loop of the gyroscope. The self-calibration is started after receiving an external GMD instruction. The MCU calibration processing algorithm unit sends out an excitation signal to realize feeding, receives an acquired signal of the state observer, and calculates and processes the self-calibration algorithm according to the excitation signal and the acquired signal. The excitation is external relative to the closed-loop control loop of the original gyroscope.

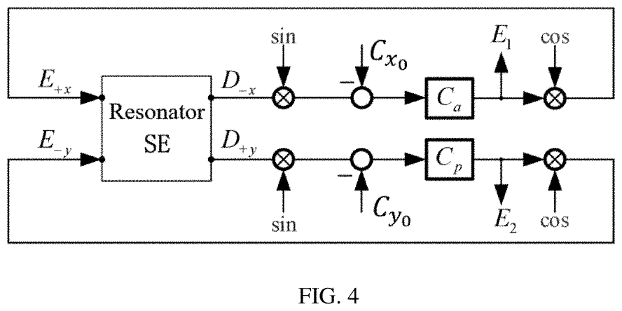

The control block diagram of the gyroscope in working mode 1 is shown in FIG. 4. In the analysis, two state observers E₁ and E₂ are arranged, which are the output values of an antinode controller and a node controller, respectively. In order to introduce the calibration principle conveniently, the PLL and quadrature coupling closed-loop control loop are ignored in the control block diagram.

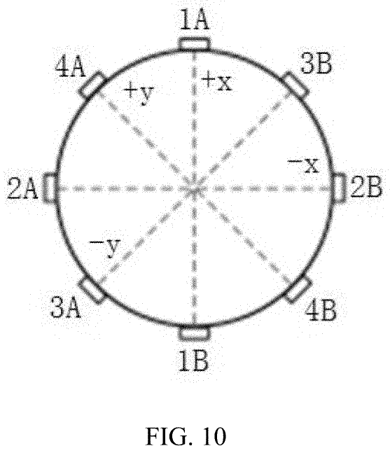

In FIGS. 4 and 6, D₋ₓ refers to the detection end of the primary mode and represents the detecting electrode 2A/2B of the primary mode in FIG. 10, E₊ₓ refers to the driving end of the primary mode and represents the driving electrode 1A/1B of the primary mode. D_{+y} refers to the detection end of the secondary mode and represents the detecting electrode 4A/4B, E_{-y} refers to the driving end of the secondary mode and represents the driving electrode 3A/3B. Cₐ refers to the closed-loop controller of the antinode axis, Cₓ₀ is the set vibration amplitude of the antinode. Cₚ is the closed-loop controller of the node axis, C_{y0} is the set vibration amplitude of the node. In the deep closed-loop negative feedback mode, C_{y0}=0 is usually set.

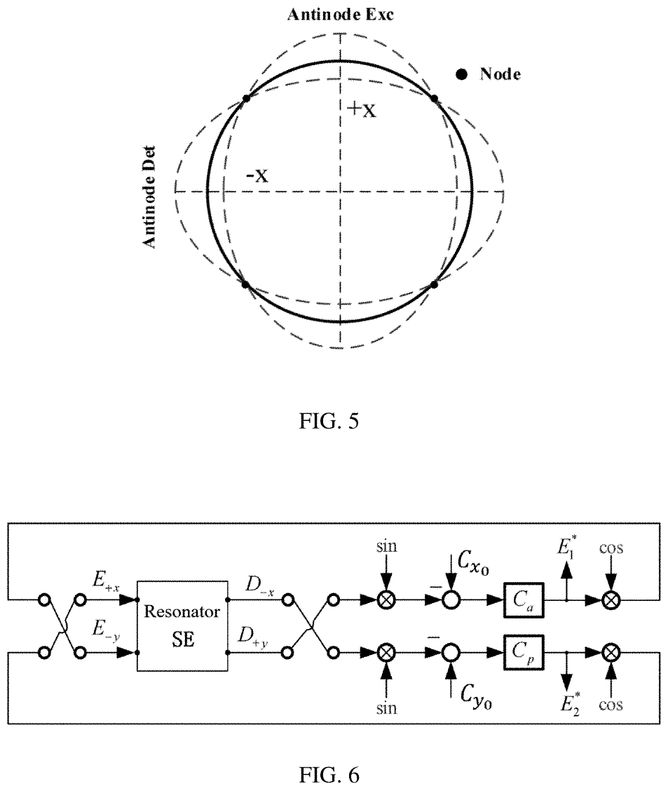

In working mode 1, the X axis (i.e., +x/−x axis in FIG. 10) is the antinode axis, and the Y axis (i.e., −y/+y axis in FIG. 10) is the node axis. The vibration mode of the resonator in working mode 1 is shown in FIG. 5, and the output of the antinode axis controller at this time is:

E₁=G₁*Cₓ_{₀} (4.51)

The output of the node controller is:

E₂=G₂*Cₓ_{₀}(Ω−B) (4.52)

where,

G₁=g_{D}_{_{−x}}·g_{E}_{₊ₓ} (4.53)

G₂=g_{D}_{_{+y}}·g_{E}_{_{−y}} (4.54)

g_{D-x} and g_{E+x} are the measured gain coefficient and feedback gain coefficient of the antinode axis in working mode 1, and similarly, g_{D+y} and g_{E-y} are the measured gain coefficient and feedback gain coefficient of the node axis in working mode 1. The measured gain usually refers to the proportional coefficient for converting an external input Coriolis force into a capacitance change (such as quartz hemispherical resonator and MEMS resonator) or a charge change (a piezoelectric ceramic resonator, such as a metal resonator vibrating gyro, Quapason™, etc.), and the feedback gain coefficient usually refers to the proportional coefficient for converting a voltage output into a feedback force (torque), such as the inverse piezoelectric effect of piezoelectric ceramic or capacitive electrostatic force feedback, etc. B is the bias of the gyroscope. Ω refers to the input angular rate.

The X/Y axis is switched to make the gyroscope work in state 2, i.e. working mode 2. The control block diagram of the gyroscope is shown in FIG. 6.

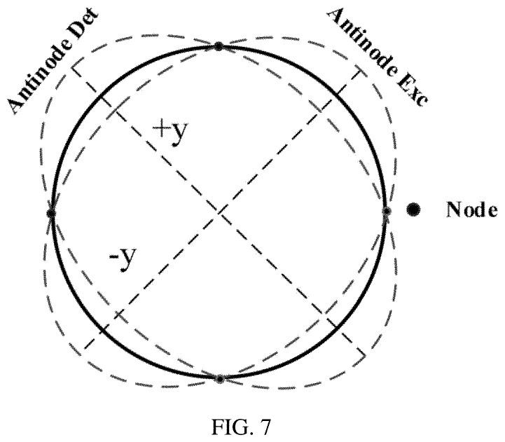

At this time, the antinode axis is along the Y axis (i.e., −y/+y-axis in FIG. 10) and the node axis is along the X axis (i.e., +x/−x-axis in FIG. 10). As shown in FIG. 7, the output of the antinode axis controller in the working mode 2 is:

E₁*=G₂*Cₓ_{₀} (4.55)

The output of the node controller in working mode 2 is:

E₂*=−G₁*Cₓ_{₀}(Ω+B) (4.56)

Equation (4.52) and equation (4.56) constitute the basic relationship between bias self-calibration and self-test of the gyroscope.

It can be seen that when the gyroscope works at two equilibrium positions at an angle of 45 degrees with each other, and assuming that the state switching time at the two positions is short and the actual input angular rate of the gyroscope remains unchanged, and further assuming that materials of the detecting electrodes and the driving electrodes of the antinode axis and node axis of the hemispherical resonator are completely consistent, i.e., G₁=G₂=G, the bias can be obtained from equations (4.52) and (4.56):

$$B = ( \frac{{E}_{2} + {E}_{2}^{*}}{2} ) \times SF \qquad ( 4.57 )$$

The calculated input angular rate value is:

$$Ω = ( \frac{{E}_{2} - {E}_{2}^{*}}{2} ) \times SF \qquad ( 4.58 )$$

In this equation, SF refers to the scale factor of the gyroscope, SF∝G·Cₓ_{₀}. Equations (4.57) and (4.58) constitute the basic relationship of the gyroscope self-calibration principle.

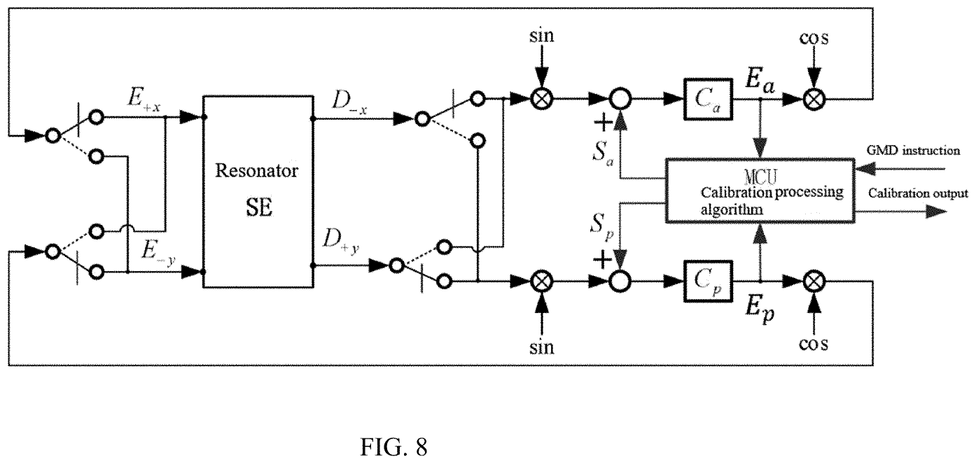

Modeling and implementation of self-calibration: in order to ensure the normal operation of the gyroscope in the process of self-calibration, especially to avoid the energy loss of the resonator during state switching, standing wave precession is more effective and reliable. According to the present invention, the whole angle free precession mode is combined with the force balance mode by combining the work flow of the GMD, and two states (i.e., two working modes) are switched through the precession of the antinode axis. According to the control strategy of the gyroscope, the biggest difference between whole angle mode and deep negative feedback rate mode is that the latter suppresses free precession through feedback depth negative feedback technology. As shown in FIG. 8, in essence, antinode control is consistent with node control, and the only difference is that the antinode axis is set with a fixed amplitude and the node axis is set with an amplitude of 0°. Based on this consideration, by the known given excitation signals, the antinode axis and node axis of the standing wave can precess freely according to the set angular rate, and the control strategy is set as shown in FIG. 8. The excitation signals include a first excitation signal Sₐ and a second excitation signal Sₚ. The first excitation signal Sₐ and the second excitation signal Sₚ are respectively combined with the demodulated primary mode detection signal D₋ₓ and the demodulated secondary mode detection signal D_{+y} to realize feeding.

In FIG. 8, the calibration algorithm controls a processor module to generate harmonic excitation signals as follows:

Sₐ=G_{A} cos θ (4.59)

Sₚ=G_{A} sin θ (4.60)

Sₐ and Sₚ represent the corresponding harmonic excitations respectively, and G_{A} is the gain coefficient of the excitation.

Where θ=2λ, 2 is the precession angle of the antinode axis relative to the initial position.

Coriolis force is proportional to the input angular rate, so the precession angle is set to change according to a certain time interval T, and the equivalent angular rate is obtained by differentiating θ:

\dot{θ}=Ω_{c} (4.61)

At this time, the antinode axis and node axis precesses freely, and signals acting on controllers Cₐ and Cₚ are the synthesis of the output signal of the antinode axis and the output signal of node axis, from which the outputs of observers Eₐ and Eₚ are:

Eₐ=G₁G_{A}(cos θ−2 sin θ(κ\hat{Ω}+Ω_{c}+b sin 2(θ−θ_{τ}))) (4.62)

Eₚ=G₂G_{A}(sin(π−θ)−2 cos(π−θ)(κ\hat{Ω}+Ω_{c}+b sin 2(θ−θ_{τ}))) (4.63)

In equations (4.62) and (4.63), the signals acquired by state observers Eₐ and Eₚ include four parts, namely, the force to maintain the vibration amplitude of antinode axis, the Coriolis force caused by the input angular rate, the precession Coriolis force caused by external given excitation, and the harmonic force caused by anisodamping error. By the known given excitation, the position of the antinode axis of the resonator is changed, thus increasing the observability of constant drift related to anisodamping error and realizing the estimation of constant drift. The superscript with a sign \hat{ } indicates an estimated value or calculated value, and the superscript without it indicates a state value.

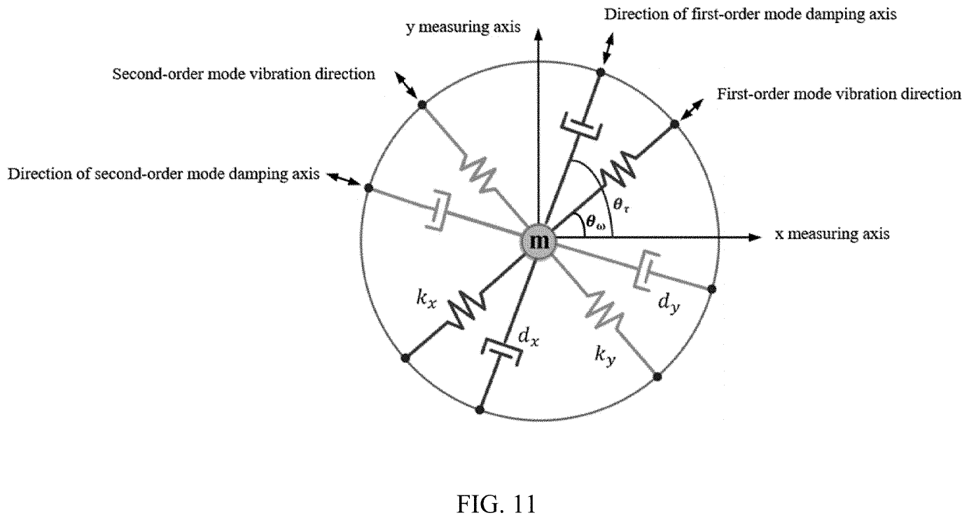

Ω_{c} represents the excitation Coriolis force generated by the excitation signals; k represents the Bryan's factor of a fully symmetric Coriolis vibratory gyroscope, and its value is only related to the shape of the resonator, b represents the bias error caused by anisodamping error, θ_{τ} indicates the anisodamping error angle of the resonator, as shown in FIG. 11, which shows that the error source of the solid-state resonator gyroscope mainly comes from frequency split and anisodamping error, and two corresponding angles are given.

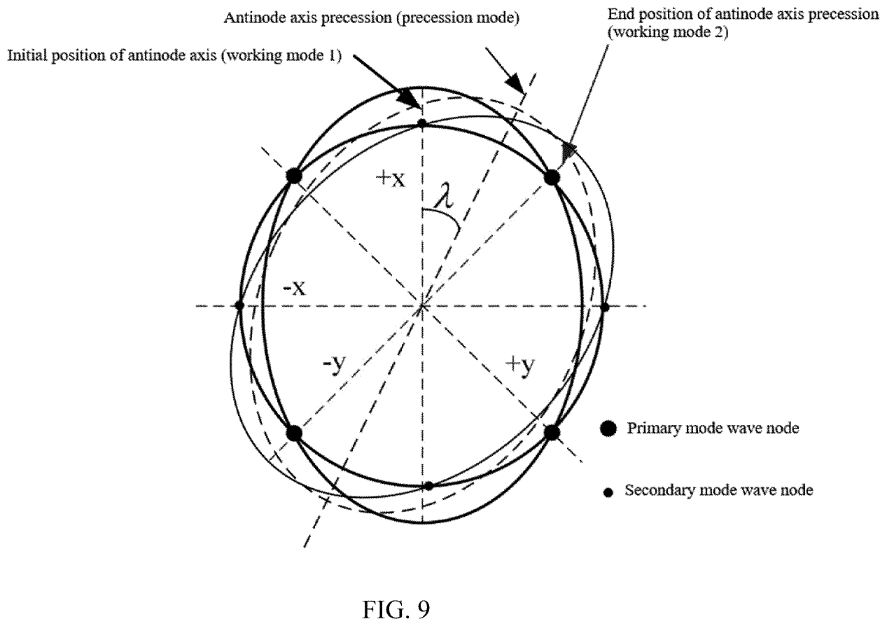

According to equations (4.62) and (4.63), the calibration process is divided into three physical processes, which are realized by the control timing of the processor as shown in FIG. 9.

1) Initial Position (Working Mode 1)

The gyroscope is in working mode 1. At this time, the antinode axis is X, the node axis is Y, and θ=0° in equations (4.62) and (4.63). At this time, the driving electrodes of the antinode axis are 1A and 1B, the measuring electrodes are 2A and 2B, the driving electrodes of the node axis are 3A and 3B, and the measuring electrodes are 4A and 4B. By combining the control system design with calculation method, the outputs of observers Eₐ and Eₚ are acquired and stored as follows:

Eₐ¹=G₁G_{A} (4.64)

Eₚ¹=2G₂G_{A}(κ\hat{Ω}−b sin 2θ_{τ}) (4.65)

2) Precession Process

An instruction is sent to realize the precession of the antinode axis and node axis of the gyroscope at a fixed precession angular rate until θ=90°. At this time, the steady-state outputs of the driving axis and the measuring axis are shown in equations (4.62) and (4.63).

3) End Position (Working Mode 2)

At the position θ=90°, precession is stopped, and the gyroscope works normally at position 2. At this time, the antinode axis is Y, the node axis is X, the driving electrodes of antinode axis are: 3A and 3B, the measuring electrodes are 4A and 4B, the driving electrodes of node axis are 1A and 1B, and the measuring electrodes are 2A and 2B. The steady-state output of the gyroscope is shown in equations (4.66) and (4.67), and the outputs of observers Eₐ and Eₚ are acquired and stored as follows:

Eₐ²=−2G₁G_{A}(κ\hat{Ω}−b sin 2θ_{τ}) (4.66)

Eₚ²=G₂G_{A} (4.67)

In the same way, assuming that G₁ and G₂ can be measured accurately, similarly, for the sake of briefness, assuming G₁=G₂=G, the input angular rate and bias of the calibrated gyroscope can be estimated by equations (4.65) and (4.66), and the principle is similar to that of equations (4.52) and (4.56).

The above is an analysis of the estimation methods of the input angular rate and bias under ideal conditions, in fact, due to the non-ideal factors of a resonator, especially the differences in the characteristics of materials of the driving electrodes and the detecting electrodes of the antinode and node, in the harsh environment of high temperature and vibration, the long-term stress release and temperature influence cause the gain coefficient in the two measurement modes to change along with time and temperature, which makes the scale factor have errors. According to the definition of the institute of electrical and electronics engineers (IEEE) standard, when given different input angular rates (the input is an angle for a whole angle mode) correspond to different output values (an analog value, a digital value, a frequency value and on the like) of the gyroscope, the ratio of an output value to an input value (or a fitting value) is called a scale factor. The calculation method of a scale factor is usually calibrated and calculated by externally inputting a given signal, such as the angular rate value given by the rate table. Generally, an off-line method is adopted, that is, before gyroscope is used, testing and calibration are realized by simulating given input excitation or hardware-in-the-loop simulation. For a rate gyroscope, given analog input excitation includes using accurate angular rate, temperature and angular rate change (also called angular acceleration) achieved by table excitation to test and calculate the key characteristics such as constant value of a scale factor, linearity, stability, repeatability, temperature characteristics related to temperature, bandwidth, etc. After testing, off-line compensation algorithm is generally performed, and relevant parameters are fixed through program input. It can be said that once it leaves the factory, the relevant parameters are fixed and cannot be changed. The precision or stability of the scale factor directly determines the precision of the gyroscope. In practical applications, the off-line model made before leaving the factory is often failed or losses precision due to stress release, aging and environmental factors of a gyro sensing unit, that is, the repeatability error of the scale factor.

Therefore, it is another focus of GMD calibration algorithm research to develop a method capable of simulating the off-line environment on the ground and realizing real-time testing and calibration of scale factors during using (referred to as in-line). Different from the GMD bias calibration method, the scale factor calibration method does not need to switch the antinode axis and node axis, and identifies the forward channel gain (mainly including the driving gain and measuring gain of the sensing unit) by observing the response of the excitation signal at a given frequency. Therefore, the real-time measurement and calibration of the scale factor can also be realized through the architecture built in FIG. 8. This method is directly cited in the present invention and will not be described in detail.

Since a Bryan's factor is related to the structure of a resonator, it is a stable value, which can be set to 1 in analysis. The scale factors of the working mode 1 and working mode 2 are defined as SFₚ₁ and SFₚ₂, respectively, then the estimation of the input angular rate and bias error can be obtained according to equations (4.68) and (4.69),

\hat{Ω}=½(Eₚ¹*SFₚ₁−Eₐ²*SFₚ₂) (4.68)

\hat{B}=½(Eₚ¹*SFₚ₁−Eₐ²*SFₚ₂) (4.69)

In equations (4.68) and (4.69), SFₚ₁ and SFₚ₂ are the scale factors of the first position and the second position, respectively, and their values can be decomposed into:

SFₚ₁==SFₚ₁₀+ΔSFₚ₁+δSFₚ₁ (4.70)

SFₚ₂=SFₚ₂₀+ΔSFₚ₂+δSFₚ₂ (4.71)

In equations (4.70) and (4.71), SFₚ₁₀ and SFₚ₂₀ are design values, and their values are known. ΔSFₚ₁ and ΔSFₚ₂ are error values that can be identified by scale factor self-calibration. δSFₚ₁ and δSFₚ₂ are residual values after calibration. SFₚ₁ and SFₚ₂ are defined as the expressions of scale factors at two positions, and the calculation method of acquiring scale factors is the IEEE standard, which will not be repeated here.

The relationship between the residual value and the design value is set as follows:

δSFₚ₁≈δSFₚ₂≈εSFₚ₁₀≈εSFₚ₂₀ (4.72)

In equation (4.72), ε is the relative error value of scale factor residuals, the actual test value is ε=1000 ppm, and then the input angular rate estimation error by the bias self-calibration method can be obtained as follows:

$$δ \hat{Ω} = \frac{ɛ}{2} {SF}_{p10} ( {E}_{p}^{1} - {E}_{a}^{2} ) \qquad ( 4.73 )$$

For MWD (measurement while drilling) drilling stop state, since the fixed input of the gyroscope is the ground velocity component, for example, the latitude in the laboratory is 40° and the ground velocity component is about 12°/h, the final self-calibration accuracy is about:

$$δ \hat{Ω} = \frac{ɛ}{2} {SF}_{{p}_{⊙}} ( {E}_{p}^{1} - {E}_{a}^{2} ) \approx 1000 \times {10}^{- 6} * 12 de \text{g} \text{/h} = 1.2 \times {10}^{- 2} de \text{g} \text{/h} \qquad ( 4.74 )$$

According to equation (4.24), the final azimuth measurement accuracy is about 0.06°, which is far better than the design target value of 1°.

So far, the basic principle of bias self-calibration of the gyroscope is analyzed. Combined with its application in a GMD, FIG. 2 shows the related design timing and operation flow. Under the static base, the constant bias of three gyroscopes is calibrated by the combination of scale factor self-calibration and bias self-calibration. Because the GMD works in a slight-disturbance or completely static working environment, the constant bias and input angular rate of the gyroscopes can be estimated by the method of bias self-calibration at any well inclination angle in the horizontal section. In the GMD design, relevant instructions are provided in the microprocessor to realize bias calibration at any position, which is complementary to the bias calibration scheme of the position changing mechanism.

The self-calibration method of the present invention is especially suitable for a GMD system, and the gyroscope starts self-calibration after receiving a GMD self-calibration instruction. Specific calibration steps include:

Step 1, a self-calibration program is started,

Step 2, the gyroscope performs the scale factor calibration in working mode 1, and the calibration formula is equation (4.70). When the gyroscope is in working mode 1, the antinode axis is X, the node axis is Y, and the precession angle parameter θ=0°,

Step 3, the gyroscope outputs the observer data in working mode 1, that is, the data of two observers Eₐ and Eₚ that are calculated and output by using equations (4.64) and (4.65);

Step 4, precession control of the antinode axis. After receiving the precession instruction, the antinode axis and node axis of the gyroscope precess according to the preset fixed precession angular rate, and the steady-state output of the driving axis and the measuring axis at this time is equation (4.62) and equation (4.63), that is, the output signals of the observers Eₐ and Eₚ in a precession mode,

The signals of the two observers include: the force for maintaining the vibration amplitude of the antinode axis, the Coriolis force caused by the input angular rate, the precession Coriolis force caused by external given excitation and the harmonic force caused by anisodamping error. By the known given excitation, the position of the antinode axis of the resonator is changed, thus increasing the observability of constant drift related to anisodamping error and realizing the estimation of constant drift,

Step 5, the gyroscope performs scale factor calibration in working mode 2, and the calibration formula is equation (4.71),

when the gyroscope is in working mode 2, the antinode axis is Y, the node axis is X, and the precession angle parameter θ=90°,

Step 6, the gyroscope outputs the observer data in working mode 2, that is, the data of two observers Eₐ and Eₚ that are calculated and output by equations (4.66) and (4.67),

Step 7: according to the results of steps 2 and 3, steps 5 and 6 as well as equations (4.70) and (4.71), equations (4.68) and (4.69) are solved to obtain the estimation of the input angular rate and bias error, and the separation of the input angular rate from bias error is completed, thus realizing self-calibration.

After the above step 6 is completed, the antinode axis is reset and the calibration is finished. The antinode axis reset process and the calculation process of step 7 do not interfere with each other, and can be executed in no particular order or at the same time.

The calibration method of the present invention is suitable for a strapdown inertial navigation system, which includes a plurality of gyroscopes (such as triaxial gyroscope) and a plurality of accelerometers (such as triaxial accelerometer). A strapdown inertial navigation system can be applied to a measurement while drilling system and a continuous navigation measurement system, to carry out bias self-calibration of the gyroscope, thereby improving the accuracy of measurement while drilling in directional drilling or attitude measurement during navigation.

In the self-calibration and self-test process of multiple gyroscopes, real-time polling can be used, that is, when calibrating and testing a gyroscope, the gyroscope does not participate in the navigation algorithm of the system (such as attitude measurement), and the other gyroscopes work normally, and the combination of the other gyroscopes and accelerometers provides real-time navigation solution data (or attitude measurement data) until all gyroscopes are calibrated, and navigation data (or attitude measurement and initial alignment data) calculated by all calibrated gyroscopes are finally output.

The self-calibration method of the present invention is suitable for various gyroscopes. When used in a while-drilling system, self-calibration can be carried out under static and non-static states of the drill collar, but it is preferable to carry out self-calibration under the static state of the drill collar. The self-calibration accuracy of the drill collar in a static state is higher, and its azimuth measurement accuracy can reach 0.06°.

Whether the drill collar is in a static state is judged as follows: whether the sensing-velocity observation value and/or the sensing-angular-rate observation value is less than the judgment threshold is judged; if the sensing-velocity observation value and/or the sensing-angular-rate observation value is less than the judgment threshold, it is judged that the drill collar is in a static state; otherwise, it is not in a static state. The sensing-velocity observation value can be an acceleration magnitude; the sensing-angular-rate observation value can be the root mean square value of the angular rate of the gyroscope. Whether the drill collar is in a static state can also be judged by judging external disturbance, that is, whether the disturbance amount of external mud and/or the vibration amount sensed by the vibration sensor is less than a set threshold value is judged; if the disturbance amount of external mud and/or the vibration amount sensed by the vibration sensor is less than a set threshold value, it is judged that the drill collar is in a static state, otherwise, the drill collar is in a non-static state. One or both of the two methods for judging the static state of drill collars can be used alone or simultaneously.

The self-calibration method and system of the solid-state resonator gyroscope provided by the embodiments of this application are described in detail above. The description of the above embodiments is only for helping to understand the method and its core idea of this application. At the same time, according to the idea of this application, there will be some changes in the specific implementation and application range for those skilled in the art. To sum up, the contents of this description should not be construed as limitations of this application.

For example, some words are used in the description and the claims to refer to specific components. It should be understood by those skilled in the art that hardware manufacturers may use different nouns to refer to the same component. In this description and claims, differences in names are not used as a way to distinguish components, but differences in functions of components are used as a criterion to distinguish components. As “comprise” and “include” mentioned in the whole description and claims are open terms, they should be interpreted as “comprising/including but not limited to”. “Roughly” means that within the acceptable error range, those skilled in the art can solve the technical problem within a certain error range and basically achieve the technical effect. The following contents of the description are preferred embodiments for implementing this application, but the contents are for the purpose of explaining the general principles of this application, and are not intended to limit the scope of this application. The claimed scope of this application shall be as defined in the appended claims.

It should also be noted that the terms “comprising”, “including” or any other variant thereof are intended to cover non-exclusive inclusion, so that a product or system including a series of elements includes not only those elements, but also other elements not explicitly listed, or elements inherent to such a product or system. Without further restrictions, the elements defined by the sentence “including one . . . ” do not exclude that there is another identical element in the product or system including the elements.

It should be understood that the term “and/or” used in this text is only a description of the association relationship of associated objects, which means that there can be three kinds of relationships, for example, A and/or B, which can mean that A exists alone, A and B exist at the same time, and B exists alone. In addition, the character “/” in this text generally indicates that the context object is an “or” relationship.

The above description shows and describes several preferred embodiments of this application, but as mentioned above, it should be understood that this application is not limited to the form disclosed herein, and should not be regarded as an exclusion of other embodiments, but can be used in various other combinations, modifications and environments, and this application can be changed through the above teaching or related field technology or knowledge within the scope of the concept in this application. However, the modifications and changes made by those skilled in the art do not depart from the spirit and scope of this application, and should be within the claimed scope of the appended claims of this application.

1. A self-calibration method of a solid-state resonator gyroscope, wherein the method acquires output signals of key monitoring points in the solid-state resonator gyroscope in different working modes in real time by externally feeding excitation signals, and realizes separation of a bias error from an input angular rate by an algorithm, so as to calibrate a repeatability error of the solid-state resonator gyroscope.

2. The self-calibration method of a solid-state resonator gyroscope according to claim 1, wherein the excitation signals comprise a first excitation signal and a second excitation signal; the first excitation signal and the second excitation signal are respectively combined with a demodulated primary mode detection signal D₋ₓ and a demodulated secondary mode detection signal D_{+y} to realize feeding.

3. The self-calibration method of a solid-state resonator gyroscope according to claim 2, wherein the key monitoring points in the solid-state resonator gyroscope comprise output points of an antinode controller and output points of a node controller; state observers are respectively arranged at the output points of the antinode controller and the output points of the node controller, and steady-state signals of the solid-state resonator gyroscope in a first working mode and in a second working mode are output through the state observers.

4. The self-calibration method of a solid-state resonator gyroscope according to claim 1, wherein contents of the steady-state signals comprise: a force for maintaining a vibration amplitude of an antinode axis, a Coriolis force caused by the input angular rate, a precession Coriolis force generated by externally feeding excitation and a harmonic force caused by anisodamping error.

5. The self-calibration method of a solid-state resonator gyroscope according to claim 1, wherein the method comprises the specific steps:
S1, performing scale factor calibration by the solid-state resonator gyroscope in the first working mode, and obtaining a residual value δSF_{P1} after self-calibration of a first position scale factor according to a known excitation signal externally fed;
S2, outputting steady-state signals Eₐ¹ and Eₚ¹ in the first working mode by the state observers;
S3, switching from the first working mode to the second working mode by the solid-state resonator gyroscope in a manner of free precession;
S4, performing scale factor calibration by the solid-state resonator gyroscope in the second working mode, and obtaining a residual value δSF_{P2} after self-calibration of a second position scale factor according to a known excitation signal externally fed;
S5, outputting steady-state signals Eₐ² and Eₚ² in the second working mode by the state observers; and
S6, separating the bias error from the input angular rate according to results of steps S1 and S2, S4 and S5 so as to realize self-calibration of the solid-state resonator gyroscope.

6. The self-calibration method of a solid-state resonator gyroscope according to claim 5, wherein in the first working mode, the antinode axis of the gyroscope is X axis, a node axis is Y axis and a precession angle parameter is θ=0°; in the second working mode, the antinode axis of the gyroscope is Y axis, the node axis is X axis and the precession angle parameter is θ=90°.

7. The self-calibration method of a solid-state resonator gyroscope according to claim 6, wherein θ=2λ, λ is a precession angle of the antinode axis relative to an initial position.

8. The self-calibration method of a solid-state resonator gyroscope according to claim 5, wherein the process of free precession in the step S3 comprises: processing the antinode axis and the node axis of the gyroscope according to a preset fixed precession angular rate until θ=90° after receiving a precession instruction.

9. The self-calibration method of a solid-state resonator gyroscope according to claim 5, wherein after the step S5 is completed, the antinode axis is reset, the calibration is finished, the reset process of the antinode axis and the calculation process of the step S6 do not interfere with each other and are executed in no particular order.

10. A measurement while drilling system, comprising:
a strapdown inertial navigation system comprising a plurality of solid-state resonator gyroscopes, each solid-state resonator gyroscope of the plurality of resonator gyroscopes having a processor configured to:
acquire output signals of key monitoring points in a respective solid-state resonator gyroscope in different working modes in real time based on excitation signals output by the respective solid-state resonator gyroscope, and
realize separation of a bias error from an input angular rate by an algorithm, so as to calibrate a repeatability error of the solid-state resonator gyroscope.

11. The measurement while drilling system according to claim 10, wherein the measurement while drilling system judges whether a drill collar is in a static state, and if the drill collar is in the static state, the measurement while drilling system sends a self-calibration instruction to the processor of each of the plurality of solid-state resonator gyroscopes to start self-calibration.

12. The measurement while drilling system according to claim 11, wherein a specific way of judging whether the drill collar is in the static state is one or two of a first judging method and a second judging method;
the first judging method comprises the following steps: judging whether a sensing-velocity observation value and/or a sensing-angular-rate observation value is less than a judgment threshold value, if the sensing-velocity observation value and/or the sensing-angular-rate observation value is less than the judgment threshold value, judging that the drill collar is in the static state, otherwise, judging that the drill collar is not in the static state;
the second judging method comprises the following steps: judging whether a disturbance amount of external mud and/or a vibration amount sensed by a vibration sensor is less than a set threshold value; if the disturbance amount of external mud and/or the vibration amount sensed by the vibration sensor is less than the set threshold value, judging that the drill collar is in the static state; otherwise, judging that the drill collar is not in the static state.

13. The measurement while drilling system according to claim 12, wherein the sensing-velocity observation value is an acceleration magnitude; the sensing-angular-rate observation value is a root mean square value of the angular rate of the gyroscope.

14. The measurement while drilling system according to claim 10, wherein self-calibration of two and more solid-state resonator gyroscopes of the plurality of solid-state resonator gyroscopes is carried out by real-time polling whereby the two or more solid-state resonator gyroscopes are self-calibrated one by one in turn, and the two or more solid-state resonator gyroscopes being self-calibrated do not participate in a navigation algorithm of the strapdown inertial navigation system, while other solid-state resonator gyroscopes of the plurality of solid-state resonator gyroscopes work normally.

15. The measurement while drilling system according to claim 11, wherein a final azimuth measurement accuracy of the measurement while drilling system reaches 0.06°.

16. A continuous navigation measurement system, comprising:
a strapdown inertial navigation system which comprises a triaxial gyroscope and a triaxial accelerometer;
and wherein the triaxial gyroscope includes a processor configured to:
acquire output signals of key monitoring points in a respective solid-state resonator gyroscope in different working modes in real time based on excitation signals output by the respective solid-state resonator gyroscope, and
realize separation of a bias error from an input angular rate by an algorithm, so as to calibrate a repeatability error of the solid-state resonator gyroscope.
